(19) United States
(12) Patent Application Publication
(10) Pub. No.: US 2019/0058214 A1
(43) Pub. Date: Feb. 21, 2019

(54) POLYMER SOLUTION ELECTROLYTES

(71) Applicant: Medtronic, Inc., Minneapolis, MN (US)

(72) Inventor: Prabhakar A. TAMIRISA, Brooklyn Park, MN (US)

(21) Appl. No.: 15/679,397

(22) Filed: Aug. 17, 2017

(51) Int. Cl. H01M 10/0565; H01M 10/0525; H01M 4/13915; C08F 20/06; C08F 20/18

(52) U.S. Cl. CPC H01M 10/0565; H01M 10/0525; C01G 31/00; C08F 20/06; C08F 20/18; H01M 4/13915

(57) ABSTRACT

Liquid electrolyte compositions containing a lithium salt, one or more solvents having a boiling point of at least 200° C. and a solubilized polymer are disclosed. Coin cells and laminated foil pack cells containing such liquid electrolyte compositions are also disclosed.

### TECHNICAL FIELD

The disclosure relates to liquid electrolytes for batteries and batteries containing such electrolytes and specifically to liquid electrolyte compositions containing a polymer in solution.

### BACKGROUND

Lithium metal and lithium ion batteries have relied on non-aqueous liquid electrolytes as the ionic conduction medium between the electrodes (cathode and anode) of a battery. Such non-aqueous liquid electrolytes are a mixture of one or more types of three components: non-aqueous solvents, lithium salts, and additives present in small amounts relative to the solvents and lithium salts. Non-aqueous solvents are selected primarily for their capability to solvate lithium salts. Solvents with a high dielectric constant (ε>30) are preferred for achieving salt dissolution at the desired concentration. However, electrolytes containing only solvents having high dielectric constants tend to have relatively high viscosities which hinders the transport of ions under high current conditions. To improve ion transport under high current conditions, solvent mixtures of solvents having high and low dielectric constants were used to obtain high levels of salt dissolution and dissociation and a lower viscosity.

It would be desirable for an electrolyte to have a high viscosity, low volatility, low permeability through polymer seals yet have an ionic conductivity comparable to traditional non-aqueous electrolytes.

### SUMMARY

The present disclosure is directed to liquid electrolyte compositions and batteries that utilize such liquid electrolyte compositions.

The electrolyte compositions of the disclosure contain a polymer yet are single-phase and homogeneous solutions. The disclosed electrolyte compositions have relatively high viscosities, low volatility, low and stable interfacial impedance with electrodes and low permeability through for example, a polymer seal in a battery casing and have relatively high ionic conductivity (>3 mS/cm at 37° C.). The disclosed electrolytes enable the use of coin cell and aluminum foil casings for medical devices.

In one embodiment, a liquid electrolyte composition is provided that includes: a liquid solution resulting from the combination of a lithium salt; a solvent having a boiling point of at least 200° C.; and a polymer that is soluble in electrolyte composition in an amount of from 2 to 25 weight percent based on the total weight of the electrolyte composition.

In another embodiment, a battery is provided that includes: a negative electrode; a positive electrode having a thickness of from >300 μm to 5 mm; a separator; and an electrolyte composition comprising a liquid solution resulting from the combination of a lithium salt, a solvent having a boiling point of at least 200° C., and a polymer that is soluble in the electrolyte composition in an amount of from 2 to 25 weight percent based on the total weight of the electrolyte composition.

In another embodiment, a liquid electrolyte composition is provided that consists essentially of: a liquid solution resulting from the combination of a lithium salt; a solvent having a boiling point of at least 200° C.; and a polymer that is soluble in the electrolyte composition in an amount of from 2 to 25 weight percent based on the total weight of the electrolyte composition.

In another embodiment, a battery is provided that consists essentially of: a negative electrode; a positive electrode having a thickness of from >300 μm to 5 mm; a separator; and an electrolyte composition comprising a liquid solution resulting from the combination of a lithium salt, a solvent having a boiling point of at least 200° C., and a polymer that is soluble in the electrolyte composition in an amount of from 2 to 25 weight percent based on the total weight of the electrolyte composition.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

Also herein, all numbers are assumed to be modified by the term “about” and preferably by the term “exactly.” Notwithstanding that the numerical ranges and parameters setting forth the broad scope of the disclosure are approximations, the numerical values set forth in the specific examples are reported as precisely as possible. All numerical value, however, inherently contain certain errors necessarily resulting from the standard deviation found in their respective testing measurements.

Also herein, the recitations of numerical ranges by endpoints include all numbers subsumed within that range (e.g., 1 to 5 includes 1, 1.5, 2, 2.75, 3, 3.80, 4, 5, etc.).

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a graph showing the results of thermogravimetric analysis of examples of the disclosure and comparative examples;

FIG. 2. is a graph showing results of accelerated discharge test of electrolytes and coin cells of the disclosure;

FIG. 3 is a graph showing results of accelerated discharge test of electrolytes and aluminum laminated foil pack cells of the disclosure;

FIGS. 4a and 4b are graphs showing change in weight vs time at 60° C. for coin cells and aluminum laminated cells containing an example electrolyte of the disclosure and a comparative example;

FIGS. 5a and 5b are graphs showing results of accelerated discharge test of electrolytes, coin cells and aluminum laminated foil pack cells of the disclosure.

### DETAILED DESCRIPTION OF EXEMPLARY EMBODIMENTS

The disclosure is directed to liquid electrolyte compositions that contain polymer that is dissolved or solubilized within the composition and to electrochemical cells or batteries having casing constructions suitable for the characteristics of the electrolyte compositions, for example, casings having polymer seals. The liquid electrolyte compositions of the disclosure are a single liquid phase, homogeneous and nonaqueous and have a storage modulus (1 Hz, 37° C.) of less than 10 Pa as measured by dynamic mechanical analysis and an ionic conductivity that ranges from 0.9 to 13.4 mS/cm at 37° C., or an ionic conductivity of at least 0.9, desirably, at least 3 mS/cm at 37° C. The electrolyte compositions of the disclosure have low volatility and low permeability through polymer seals.

The electrolyte compositions of the disclosure do not include or excludes electrolytes that are semi-solid electrolytes, gel (or gelled) electrolytes, and solid or solid-state electrolytes and electrolytes in the form of a film. A “semi-solid” or “gel” electrolyte typically has a storage modulus (1 Hz, 37° C.) of from 10¹ to 1×10⁶ Pa as measured by dynamic mechanical analysis.

Liquid electrolyte compositions of the disclosure have a volatility (“low volatility”) represented by a weight loss of 10% or less below 90° C. in a thermogravimetric study conducted at 10° C./min and a low permeability to typical polymeric casing seal materials and can be used within semi-hermetic casings and polymer casings. The liquid electrolyte compositions can be used in primary and rechargeable batteries. The liquid electrolyte compositions of the disclosure remain a solution at temperatures down to minus 40° C.

### Lithium Salts

The liquid electrolyte compositions described in this application contain one or more lithium salts or LiX salts. Examples of such LiX salts include lithium bis(trifluoromethylsulfonyl) imide (LiTFSI), lithium bis(pentafluoroethylsulfonyl) imide (LiBETI), lithium bis(fluorosulfonyl)imide (LiFSI), lithium tris(trifluorosulfonyl) methide, lithium perchlorate (LiClO₄), lithium tetrafluoroborate (LiBF₄), lithium hexafluoroarsenate (LiAsF₆), lithium hexafluorophosphate (LiPF₆), Lithium bis(oxalatoborate) (LiBOB), Lithium trifluoromethanesulfonate (LiCF3SO3), and combinations of any of them.

The lithium salt(s) is/are present in an amount of from about 11 to about to 50 percent by weight (or weight percent) based on the total weight of the electrolyte composition including the lithium salt, solvents and polymer. In other examples, the lithium salts are present in an amount of less than 50 weight percent, more than 11 weight percent and in any amount or range in between 11 weight percent and 50 weight percent.

### Solvents

The liquid electrolyte compositions of the disclosure contain one or more solvents. The solvents in the electrolyte composition of the disclosure solubilize the lithium salt and the polymer to form a solution. Solvent or mixtures of solvents for use in the electrolyte compositions generally have a dielectric constant of greater than 30 (ε>30) and a boiling point of at least 200° C. Mixtures of one or more solvents that have a boiling point of at least 200° C. in which an individual solvent of the mixture has a boiling point of <200° C. is a solvent or mixture of solvents having a boiling point of at least 200° C. according to the disclosure. Mixtures of solvents can consist of a high dielectric constant solvent (ε>30) and a low dielectric constant solvent (ε<25). Solvents for use in the electrolyte compositions of the disclosure include propylene carbonate (PC), ethylene carbonate (EC), dimethoxyethane (DME), Gamma butyrolactone (GBL), dimethylacetamide (DMA), N-methylpyrrolidone (NMP) tetraethylene glycol dimethyl ether (tetraglyme or G4) and sulfolane. Examples of mixtures of solvents (1:1 by volume) include mixtures of PC and DME; PC and G4; GBL and G4; GBL and DME; and EC and DME. Useful solvents do not include water or excludes water and are nonaqueous.

The amount of solvent present in the electrolyte compositions described in this application range from 30 to 76 weight percent based on the total weight of the electrolyte composition. In other embodiments, the amount of solvent present in the electrolyte compositions described in this application range from 50 to 75, and from 50 to 70 weight percent based on the total weight of the electrolyte composition.

### Polymers

The liquid electrolyte compositions described in this application contain one or more polymers in solution. Useful polymers include polyethylene oxide (PEO), poly(ethylene-co-propylene oxide), poly (methyl methacrylate), poly(lithium acrylate), poly(butyl acrylate), poly(butyl methacrylate), methyl cellulose, hydroxypropyl methyl cellulose, cellulose acetate, poly(ethylene glycol) monomethacrylate, poly(ethylene glycol) dimethacrylate, poly(ethylene glycol) diacrylate, poly(ethylene glycol) methylether acrylate, and mixtures or any of them. Examples of useful PEOs are PEOs having a molecular weight of from 100,000 Da (100 kDa) to 8,000,000 Da (8,000 kDa). Specific examples include those having the following CAS # and (molecular weight; Da): 25322-68-3 (100,000); 25322-68-3 (600,000); and 25322-68-3 (5,000,000) available from Sigma-Aldrich.

The amount of polymer present in the electrolyte compositions described in this application range from 2 to 25 weight percent based on the total weight of the electrolyte composition. In other embodiments, the amount of polymer present in the electrolyte compositions described in this application range from 2 to 15 weight percent based on the total weight of the electrolyte composition.

The electrolyte compositions described in this disclosure are useful in batteries, typically containing an anode (negative electrode), a cathode (positive electrode) and a separator enclosed within a casing. Useful materials that can be used in an anode of such a battery include lithium metal, lithium alloys (Li—Al, Li—Si, Li—Sn), graphitic carbon, petroleum coke, MCMB, lithium titanate (Li₄Ti₅O₁₂), and combinations of any of them. Useful materials that can be used in a cathode in such a battery include silver vanadium oxide/carbon monofluoride (SVO/CFₓ), manganese oxide/carbon monofluoride (MnO₂/CFₓ), silver vanadium oxide (SVO), manganese oxide (MnO₂), carbon monofluoride (CFₓ), lithium cobalt oxide (LiCoO₂), lithium manganese oxide (LiMn₂O₄), lithium nickel manganese cobalt oxide LiNi_{1/3}Mn_{1/3}Co_{1/3}O₂), lithium nickel oxide (LiNiO₂), sulphur (S), and lithium sulfide (LiₓS).

### Separators

Useful materials for use in or as a separator include microporous materials including cellulose, polypropylene (PP), polyethylene (PE), PP/PE/PP (tri-layer) and microporous membranes, cloths and felts made from ceramic materials such as Al₂O₃, ZrO₂, and SiO₂ based materials that are chemically resistant to degradation from the battery electrolyte. Examples of commercially available microporous materials include Celgard™ 2500, Celgard™ 3501, Celgard™ 2325, Dreamweaver™ Gold, and Dreamweaver™ Silver. Other useful materials include nonwoven PP materials and non-woven PP laminated to microporous separators commercially available as Freudenberg/Viledon™ and Celgard™ 4560 respectively.

### Anodes

Useful materials that can be used in an anode (negative polarity) of such a battery include lithium metal, lithium alloys (Li—Al, Li—Si, Li—Sn), graphitic carbon, petroleum coke, MCMB, lithium titanate (Li₄Ti₅O₁₂), and combinations of any of them.

### Cathodes

Useful materials that can be used in a cathode (positive polarity) in such a battery include silver vanadium oxide/carbon monofluoride (SVO/CFₓ), manganese oxide/carbon monofluoride (MnO₂/CFₓ), SVO, MnO₂, carbon monofluoride, lithium cobalt oxide (LiCoO₂), lithium manganese oxide (LiMn₂O₄), lithium nickel manganese cobalt oxide (LiNi_{1/3}Mn_{1/3}Co_{1/3}O₂), lithium nickel oxide (LiNiO₂), lithium nickel cobalt aluminum oxide (LiNi_{0.8}Co_{0.15}Al_{0.05}O₂), and lithium sulfide (LiₓS).

Carbon monofluoride, often referred to as carbon fluoride, polycarbon monofluoride, CFx, or (CFx)n or graphite fluoride is a solid, structural, non-stoichiometric fluorocarbon of empirical formula CFx wherein x is 0.01 to 1.9, 0.1 to 1.5, or 1.1. One commercially available carbon monofluoride is (CFx)n where 0<x<1.25 (and n is the number of monomer units in the polymer, which can vary widely).

Silver vanadium oxide includes compounds having the general formula AgₓV_{y}O_{z} wherein x=0 to 2; y=1 to 4; and z=4 to 11, for example, AgV₂O₅, Ag₂V₄O₁₁, Ag_{0.35}V₂O_{5.8}, Ag_{0.74}V₂O_{5.37} and AgV₄O_{5.5}.

These materials can also be referred to as “electrode active materials”, “anode active materials” or “cathode active materials”, as appropriate for the particular material.

Cathodes of this disclosure have a total thickness of greater than 300 micrometers and up to a total thickness of 5 millimeters and can be any range of thicknesses or any single thickness between >300 μm and 5 mm. In other examples, cathodes have a total thickness of from 0.5 mm to 2.0 mm. Cathodes of this disclosure can comprise a single cathode/current collector sheet or can comprise stacks of thinner individual cathode/current collector sheets, with stack of current collectors terminating in a single common connection.

Useful anodes and cathodes can be in the form of planar electrodes. A planar cell or electrode is a plate electrode comprising a metal film substrate and electrode active material deposited or formed onto the metal film substrate. Electrode plates can be stacked to form “stacked plate” batteries of alternating anodes and cathodes separated by a separator.

Useful casings for the batteries described in this application can be hermetic or semi-hermetic. Examples of hermetic casings include welded metal cases having a glass-metal feedthrough or a ceramic feedthrough. Examples of semi-hermetic casings include coin cells, laminated metal foil packs, adhesive bonded metal cases, and crimped metal cases. The semi-hermetic casings are typically sealed using a seal made of a polymer and are not welded. Examples of such polymer materials useful for such seals include polypropylene, polyethylene, polyisobutylene and poly(butadiene). Semi-hermetic casings may also be made from polymer laminated aluminum foils sealed with thermoplastic adhesive seals consisting of polyolefin and acid-modified polyolefin materials.

The batteries described in this disclosure can be used to supply power to a variety of devices, for example, medical devices. For example, the batteries described in this disclosure can be used in implantable medical devices, for example implantable pulse generators such as pacemakers (to be used with leads or leadless, fully insertable, pacemakers such as MICRA™ leadless pacemaker, from Medtronic, plc.) and neurostimulators, and implantable monitors such as an implantable cardiac monitors, for example Reveal LINQ™ and REVEAL™ XT insertable cardiac monitors available from Medtronic, Inc. and implantable leadless pressure sensors to monitor blood pressure. Implantable cardiac monitors can be used to measure or detect heart rate, ECG, atrial fibrillation, impedance and patient activity. All of the insertable medical devices have housings (typically made of titanium), a memory to store data, a power source (for example, a battery) to power sensors and electronics and electronic circuitry to receive physiological measurements or signals from sensors and to analyze the signals within the housing and to communicate data from the device and are typically hermetically sealed. The Reveal LINQ™ insertable cardiac monitor has a width that is less than its length and a depth or thickness less than its width.

The batteries described in this disclosure can also be used in external medical devices such as external sensors or monitors in the form of a patch or wearable sensor (for example SEEQ™ wearable cardiac sensor, from Medtronic Monitoring, Inc.). Such wearable sensors have one or more individual sensors which contact skin and measure or detect for example impedance, ECG, thoracic impedance, heart rate and blood glucose levels. Such wearable sensors typically have an electronic circuit board connected to the sensors, an adhesive or strap or band to contact the sensors to a patient's skin, and a power source to power the electronics and to communicate data to a receiving device. Such batteries can have casings that are hermetic or semi-hermetic. The hermetic and semi-hermetic batteries described in this disclosure can be used in medical facilities such as hospitals and clinics in pulse oximeters and wireless nerve integrity monitors.

In an embodiment, an electrolyte composition consists essentially of a liquid solution resulting from the combination of a lithium salt;

a solvent having a boiling point of at least 200° C.; and
a polymer that is soluble in the electrolyte composition, solvent or mixture of solvent and lithium salt in an amount of from 2 to 25 weight percent based on the total weight of the electrolyte composition.

In an embodiment, a battery consists essentially of

a negative electrode;
a positive electrode having a thickness of from >300 μm to 5 mm;
a separator between the negative and positive electrodes; and
an electrolyte composition consisting essentially of a liquid solution resulting from the combination of a lithium salt, a solvent having a boiling point of at least 200° C., and a polymer that is soluble in the electrolyte composition, solvent or mixture of solvent and lithium salt in an amount of from 2 to 25 weight percent based on the total weight of the electrolyte composition.

### EXAMPLES

### Examples 1-19

Liquid electrolyte compositions were prepared by first dissolving lithium salt in either a single solvent or a mixture of solvents until the lithium salt is dissolved. Polymer was stirred into to the lithium salt/solvent solution to create a liquid electrolyte composition wherein the polymer is solubilized. Dissolution of the polymer in the electrolyte solution was ensured by either stirring the composition at an elevated temperature (60° C.), or by mechanically mixing of the polymer in the lithium salt/solvent solution to achieve dispersion of the polymer, and then subsequently storing the resulting solution/dispersed polymer at an elevated temperature (60° C.), to complete dissolution of the polymer.

### Comparative Examples (CE) 1-13

Comparative Examples (CE) 1 and 3-12 were prepared by dissolving lithium salt in either a single solvent or a mixture of solvents until the lithium salt is dissolved. CE2 was purchased from BASF, Florham Park, N.J.

### Results:

Glossary:

| Abbreviation | Description |
|---|---|
| GBL | Gamma butyrolactone |
| PC | Propylene carbonate |
| DME | 1,2-Dimethoxyethane |
| G4 | Tetraethylene glycol dimethyl ether |
| PEO | Polyethylene oxide (5000 kDa and 600 kDa) |
| PMMA | Poly (methyl methacrylate) |
| PEGDA | Polyethylene glycol diacrylate |
| EP1010NH | Random copolymer of ethylene oxide and propylene oxide |
| | with 10 wt % propylene oxide (CAS Number: 9003-11-6) |
| NMP | N-methylpyrrolidone |
| DMAC | Dimethylacetamide |

TABLE 1

| | | | | | | | | | Solvent | |
|---|---|---|---|---|---|---|---|---|---|---|
| | | | | | | | | | 1 + Solvent | Conductivity |
| | Solvent | Solvent | Solvent | Solvent | | Salt | | Polymer | 2 | @ 37° C. |
| Example | 1 | 1 wt % | 2 | 2-wt % | Salt | wt % | Polymer | wt % | wt % | mS/cm |
| CE 1 | GBL | 77.0% | | 0.00% | LiTFSI | 23.0% | | 0.00% | 77.0% | 9.84 |
| 1 | GBL | 69.3% | | 0.00% | LiTFSI | 20.7% | PEO | 10.0% | 69.3% | 7.22 |
| | | | | | | | (5000 kDa) | | | |
| CE 2 | PC | 48.5% | DME | 34.9% | LiAsF6 | 16.6% | | 0.00% | 83.4% | 15.0 |
| 2 | PC | 43.6% | DME | 31.4% | LiAsF6 | 14.9% | PEO | 10.0% | 75.1% | 13.4 |
| | | | | | | | (5000 kDa) | | | |
| 3 | PC | 38.8% | DME | 27.9% | LiAsF6 | 13.3% | PEO (5000 | 20.0% | 66.7% | 9.02 |
| | | | | | | | kDa) | | | |
| 4 | PC | 34.0% | DME | 24.4% | LiAsF6 | 11.6% | PEO (5000 | 30.0% | 58.4% | 5.54 |
| | | | | | | | kDa) | | | |
| 5 | PC | 43.6% | DME | 31.4% | LiAsF6 | 14.9% | PMMA | 10.0% | 75.1% | 8.30 |
| | | | | | | | (550 kDa) | | | |
| 6 | PC | 38.8% | DME | 27.9% | LiAsF6 | 13.3% | PMMA | 20.0% | 66.7% | 4.16 |
| | | | | | | | (550 kDa) | | | |
| 7 | PC | 34.0% | DME | 24.4% | LiAsF6 | 11.6% | PMMA | 30.0% | 58.4% | 2.35 |
| | | | | | | | (550 kDa) | | | |
| CE 3 | PC | 43.0% | G4 | 36.2% | LiTFSI | 20.8% | | 0.00% | 79.2% | 6.97 |
| 8 | PC | 38.8% | G4 | 32.5% | LiTFSI | 18.7% | PEO (5000 | 10.0% | 71.3% | 4.81 |
| | | | | | | | kDa) | | | |
| 9 | PC | 34.4% | G4 | 28.9% | LiTFSI | 16.6% | PEO (5000 | 20.0% | 63.4% | 3.10 |
| | | | | | | | kDa) | | | |
| CE 4 | | 0.00% | G4 | 75.6% | LiTFSI | 24.4% | | 0.00% | 75.6% | 3.75 |
| 10 | | 0.00% | G4 | 68.0% | LiTFSI | 22.0% | PEGDA | 10.0% | 68.0% | 3.03 |
| | | | | | | | (750 Da) | | | |
| 11 | | 0.00% | G4 | 52.9% | LiTFSI | 17.1% | PEGDA | 30.0% | 52.9% | 1.80 |
| | | | | | | | (750 Da) | | | |
| 12 | | 0.00% | G4 | 37.8% | LiTFSI | 12.2% | PEGDA | 50.0% | 37.8% | 0.904 |
| | | | | | | | (750 Da) | | | |
| 13 | | 0.00% | G4 | 50.5% | LITFSI | 43.5% | PEO | 6.0% | 50.5% | 4.07 |
| | | | | | | | (5000 kDa) | | | |
| 14 | | 0.00% | G4 | 68.0% | LiTFSI | 22.0% | EP1010NH | 10.0% | 68.0% | 2.29 |
| | | | | | | | (~100 | | | |
| | | | | | | | kDa) | | | |
| 15 | | 0.00% | G4 | 60.5% | LITFSI | 19.5% | EP1010NH | 20.0% | 60.5% | 1.51 |
| | | | | | | | (~100 kDa) | | | |
| CE 5 | | 0.00% | G4 | 53.7% | LiTFSI | 46.3% | | 0.00% | 53.7% | 2.80 |
| 16 | | 0.00% | G4 | 47.0% | LiTFSI | 40.5% | EP1010NH | 12.5% | 47.0% | 1.26 |
| | | | | | | | (~100 | | | |
| | | | | | | | kDa) | | | |
| 17 | | 0.00% | G4 | 43.0% | LiTFSI | 37.0% | EP1010NH | 20.0% | 43.0% | 1.94 |
| | | | | | | | (~100 | | | |
| | | | | | | | kDa) | | | |
| 18 | | 0.00% | G4 | 37.6% | LiTFSI | 32.4% | EP1010NH | 30.0% | 37.6% | 1.53 |
| | | | | | | | (~100 | | | |
| | | | | | | | kDa) | | | |
| 19 | PC | 42.4% | DME | 30.6% | LiAsF6 | 14.5 | PEO | | | |
| | | | | | | | (5000 kDa) | | | |
| CE 6 | GBL | 78.6% | | | LiBF4 | 21.4% | | | 78.6% | 4.28 |
| CE 7 | GBL | 57.9% | | | LiBF4 | 42.1% | | | 57.9% | 2.00 |
| CE 8 | EC | 69.9% | | | LiPF6 | 30.1% | | | 69.9% | 8.97 |
| CE 9 | GBL | 69.4% | | | LiPF6 | 30.6% | | | 69.4% | 5.25 |
| CE 10 | NMP | 80.9% | | | LiBF4 | 19.1% | | | 80.9% | 4.20 |
| CE 11 | NMP | 72.3% | | | LiPF6 | 27.7% | | | 72.3% | 4.70 |
| CE 12 | DMAC | 78.8% | | | LiBF4 | 21.2% | | | 78.8% | 6.20 |
| CE 13 | | | G4 | 38.2% | LiTFSI | 49.3% | PEO | 12.5% | | |
| | | | | | | | (5000 kDa) | | | |

Addition of polymer to lithium salt/solvent compositions does not degrade the composition's ionic conductivity significantly, especially when polymer content is <20%, and the polymer has a glass transition temperature (T_{g}) below 0° C. This observation is true for liquid electrolytes with salt concentrations of 1 M salt concentration. In some lithium salt/solvent compositions, especially when the salt concentration is greater than 1 M, e.g. 40 mol % LiTFSI/tetraglyme, addition of a polymer having a T_{g} below 0° C., such as PEO, to the lithium salt/solvent composition results in an increase in ionic conductivity of the resulting liquid electrolyte composition.

The data show addition of polymer in lithium salt/solvent compositions reduces volatility, increases viscosity, and maintains single phase solution characteristics in many cases. Lithium salt/solvent compositions that have been investigated for forming polymer solutions are of three types: lithium salt in a low dielectric constant solvent (CE4 & CE5), lithium salt in a high dielectric constant solvent (CE1, CE6, CE7, CE8, CE9, CE10, CE11, CE12), and lithium salt in a mixture of solvents with low and high dielectric constants (CE2 & CE3); in some examples, lithium salt and polymer concentration was varied to study the dependence of ionic conductivity on these parameters. Liquid electrolyte compositions with the highest ionic conductivity are achieved with a combination of solvents, especially one of low dielectric constant (ε<25), and one with dielectric constant (ε>30) (Example 2), at salt concentrations of 1 M in the liquid electrolyte, and low polymer concentrations (<10 wt % based on the mixture of liquid electrolyte and polymer).

### Thermogravimetric Analysis

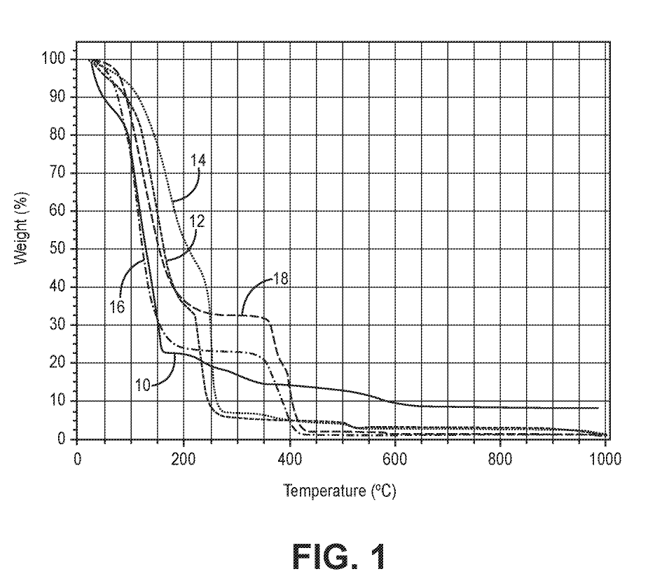

Thermogravimetric analysis was performed on certain electrolyte compositions. The graph of FIG. 1 shows the results of thermogravimetric analysis on the electrolytes of Examples 1, 2 and 3 and of Comparative Examples 1 and 2. Curve 10 represents data from Comparative Example 2. Curve 12 represents data from Example 2. Curve 14 represents data from Example 3. Curve 16 represents data from Comparative Example 1. Curve 18 represents data from Example 1. The data in FIG. 1 show that it is possible to reduce the volatility of highly volatile liquid lithium salt/solvent compositions through the addition of a polymer to the electrolyte and achieving a polymer solution electrolyte. For example, liquid composition represented by CE2 and curve 10 loses 10% of its original weight at a temperature of 50.3° C., but addition of polymer (PEO_5000 kDa) to the composition at levels of 10 wt. % (curve 12, Example 2) and 20 wt. % (Curve 14, Example 3) increases the temperature for 10% weight loss in original weight to 94.1° C. and 115.98° C. respectively. Similarly, liquid composition represented by CE1 and curve 16 loses 10% of its original weight at 80.03° C., but addition of polymer (PEO_5000 kDa) to the composition at a level of 10 wt % (Curve 18 and Example 1) increases the temperature for 10% weight loss in original weight to 95.37° C. Typically, low volatility has been achieved with ionic liquid electrolytes or solvate ionic liquid electrolytes, or solid state electrolytes. Both ionic liquid and solid state electrolytes pose challenges in achieving high performance batteries since both typically possess low ionic conductivity and/or pose challenges from diffusion limitations of ions in electrolytes. By incorporation of polymer to otherwise highly volatile liquid lithium salt/solvent compositions, electrochemical properties such as high ionic and diffusion properties of electrolytes are preserved while suitably reducing volatility for use in polymer sealed enclosures for long life applications.

### Electrical Testing

Electrical testing of liquid electrolyte compositions was conducted in battery prototypes built in either coin cells or aluminum laminated foil pack cells.

Subcomponents for the battery prototypes such as electrolyte, anode, cathode, and separator were first prepared, and subsequently assembled into enclosures and sealed.

### Electrolytes:

Liquid electrolyte compositions were prepared by procuring or preparing lithium salt/solvent compositions by combining lithium salt (LiTFSI) and solvent (gamma-butyrolactone) in 23:77 weight ratio in a dried polypropylene container and mixing with the aid of a magnetic stir bar at room temperature until a clear solution was obtained. Subsequently, dried polymer was combined with the liquid lithium salt/solvent compositions in appropriate quantities in a dried container, stirred with a glass rod to achieve good wetting of the polymer in the liquid, and stored at 60° C. for 24-48 hours until a clear solution was achieved. As a representative example, the liquid electrolyte composition of Example 1 was prepared by combining 10 parts of PEO (5000 kDa) with 90 parts of a liquid lithium salt/solvent composition containing LiTFSI and gamma-butyrolactone (23:77 weight ratio) in a dried polypropylene container, mixing with a glass rod until the polymer was uniformly wetted by the liquid electrolyte, and stored at 60° C. for 24 hours to complete dissolution of the polymer, resulting in a clear, homogeneous solution. PEO was dried at 50° C. under vacuum for 48 hours before use in preparation of the liquid electrolyte composition.

Cathode mixes were prepared using one of two methods:
1. Combining a dry cathode mix powder, consisting of silver vanadium oxide (SVO), carbon monofluoride (CFx), carbon black and PTFE (poly(tetrafluoroethylene)), with a lithium salt/solvent composition, and a polymer capable of solvating the liquid electrolyte in a planetary mixer, and mixing at room temperature until a uniform mixture was achieved. At the end of the mixing process, the mixture was baked at 87° C. for 48 hours to achieve gelation of the liquid electrolyte by the polymer (other than PTFE). This method was utilized for preparing cathode mixes having a solid fraction of ≤40%, volume in the final cathode mix containing SVO, CFx, carbon black, PTFE, and a liquid electrolyte composition consisting of lithium salt, solvent and a polymer capable of solvating the liquid electrolyte. Solids in this cathode mix are represented by SVO, CFx, carbon black, and PTFE.
2. Combining a dry cathode mix powder, consisting of silver vanadium oxide (SVO), carbon monofluoride (CFx), carbon black and PTFE (poly(tetrafluoroethylene)), with a liquid electrolyte composition (prepared by the procedure described above) in a helicone mixer, and mixing at room temperature (25° C.) until a uniform mixture was achieved. This method was utilized for preparing cathode mixes having solid fractions of 40-60% by volume in the final cathode mix. Solids in this cathode mix are represented by SVO, CFx, carbon black, and PTFE.

Dry cathode mix powder was prepared by first combining silver vanadium oxide, carbon monofluoride, carbon black, PTFE emulsion in a helicone mixer, mixing with small additions of iso-propyl alcohol and deionized water to ensure wetting of the dry ingredients by the PTFE emulsion, and mixing until a uniform mixture was achieved. The partially wet cathode mixture was baked at 150° C. for 4 hours under vacuum to vaporize water and iso-propyl alcohol initially, and subsequently baked at 275° C. for 4 hours under vacuum to vaporize surfactant from the PTFE emulsion.

Cathode sub-assemblies were prepared by first retrieving the cathode mixture from the mixer, and preparing flat sheets of cathode mixes (0.7 mm thickness) by passing them through a set of calendar rolls maintained at 60° C. In cathode mixes having solid fractions of 40-60% by volume, cathode sheets were pressed in a hydraulic press (Carver press) at 1000 lb/cm² to achieve a sheet form (if needed) prior to calendaring. Smaller sections of the desired area of the calendared sheets were cut either using a knife or scissors. For use in an aluminum laminated foil pack cell, expanded metal mesh (e.g. Titanium mesh from Dexmet), cut to an area slightly smaller than the area of the cathode sections derived from the cathode sheets, were welded to a metal tab long enough to extend through the thermoplastic polymer seal of the battery, and pressed into the cathode sections in a hydraulic press at 1000 lb/cm². The expanded metal mesh and the tab serve as the cathode current collector in the aluminum laminated foil pack cell. Cathode sheets were cut into circles, approximately 16 mm in diameter for use in coin cells of the 2032 size, and were placed in direct contact with the coin cell cup without using a current collector. To achieve cathodes that were thicker than 0.7 mm, (for example 1.4 mm), cathode sheets were calendared to 1.4 mm thickness.

Anodes were prepared by cutting lithium metal sheets of the appropriate thickness (0.3 mm-0.5 mm) to the appropriate area needed for the prototype battery being assembled (2 cm² for coin cells, 5.5 cm² for aluminum laminated foil pack cells). For use in aluminum laminated foil pack cells, the lithium metal sections from the lithium metal sheets were pressed to an expanded metal mesh (e.g. Titanium mesh from Dexmet) welded to a metal tab (titanium tab) that was long enough to extend through the thermoplastic polymer seal of the battery in the final assembled form. For use in coin cells, lithium metal circles were placed in direct contact with a metallic spacer (e.g. SS316L) in the coin cells.

Separators for battery prototypes were created from either a microporous polyolefin material (e.g. Celgard™ 2500) or a non-woven separator made from cellulose (e.g. Dreamweaver™ Silver), and incorporating a liquid electrolyte composition into the pores of the separator. Electrolyte was incorporated into the pores of the separator during assembly of the prototype in one of two methods:
1. Dipping the separator in a liquid electrolyte composition maintained at an elevated temperature (e.g. 70° C.); or
2. Dispensing the liquid electrolyte composition onto the major surface of the separator facing the electrodes and/or electrodes facing the separator during assembly of the battery prototypes.

To assemble the 2032 size coin cells, a polymer grommet (also known as a gasket) was placed in the cup (larger diameter component of the two halves of the coin cell kit), followed by placing a 16 mm diameter cathode in the cup, and within the perimeter of the gasket. A porous separator (18 mm diameter) was placed on top of the cathode; the separator was either dipped in electrolyte as described above, or electrolyte was dispensed on the cathode under the separator, and on the face of the separator. After assembling the separator, a 16 mm diameter lithium foil was placed on top of the separator, followed by a stainless steel spacer (316L SS), and a wave spring. The coin cell cover (smaller diameter component of the coin cell kit) was placed on top of the wave spring, and the assembly placed inside a coin cell press die. Coin cells were sealed by compressing the coin cell assembly in a hydraulic press.

To fabricate the aluminum laminated foil pack cells, foil material (e.g. DNP-EL40H) was drawn using custom dies to create a pocket to house the battery stack (stack of cathode/separator/anode) in a large enough sheet to fold a flat sheet over the pocket to create an enclosure when sealed on three sides. For example, a pocket of dimensions 37 mm×16 mm×4 mm was created in a sheet that measured 42 mm×45 mm to allow for 4 mm seals on three sides of the finished cells. Aluminum laminated foil cells were assembled by first placing the cathode/current collector assembly into the pocket, placing the separator on top of the cathode/current collector, and placing the anode/current collector assembly on top of the separator. Electrolyte was incorporated into the pores of the separator by dipping the separator into a 70° C. liquid electrolyte composition before placing it in the cell, or by dispensing electrolyte on the cathode and separator. Margin, of at least ˜1 mm was maintained on the separator to prevent internal shorting. The non-pocket side of the aluminum laminated foil was folded over the pocket, and a first edge seal was achieved using a linear sealer on the long side which contains the electrode tabs. The second seal was achieved along the width of the cell, again using the linear sealer. The third, and final seal was achieved under vacuum, along the width of the seal. Special polymer tabs (e.g. acid modified polypropylene, PPaF) were assembled and sealed on the electrode current collector tabs prior to even pressing the expanded metal mesh on the electrodes to mate with the edges of the aluminum laminated foil pack cells so a good bond was formed between the thermoplastic polymer and the tabs.

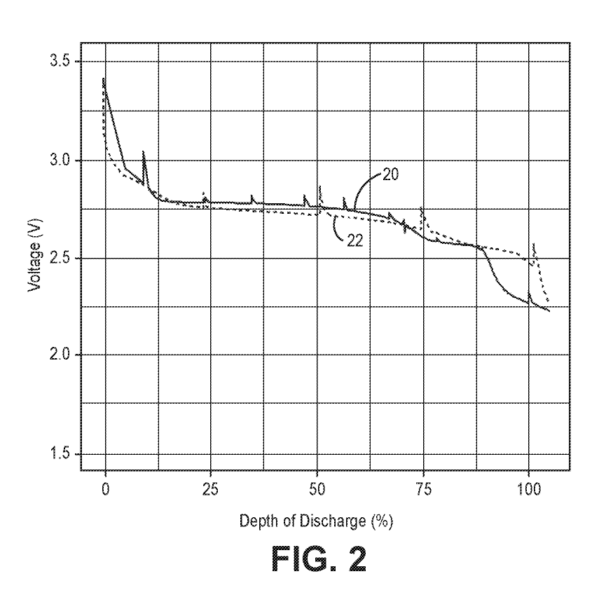

FIG. 2 shows results of electrical discharge of coin cells using the liquid electrolyte composition of Example 19. Curve 20 shows discharge data (1.5-month discharge rate) for a coin cell made using a cathode having 40% by volume dry cathode mix and a thickness of 0.7 mm. Curve 22 shows discharge data (2-month discharge rate) for a coin cell made using a cathode having 55% by volume dry cathode mix and a thickness of 0.7 mm.

The data in FIG. 2 shows that it is possible to achieve 100% of the theoretical discharge capacity at an accelerated rate with a liquid electrolyte composition of the disclosure in thick cathodes. Voltage plateaus are well defined in Curve 20 in comparison to Curve 22, and Curve 20 shows a higher average voltage in comparison to Curve 22. The results are due to the difference in the cathode volume fraction between the cells; higher cathode volume fraction, and resulting lower electrolyte volume fraction results in lower resistance in the cathode and enables a higher average voltage and also allows greater definition to the voltage plateaus.

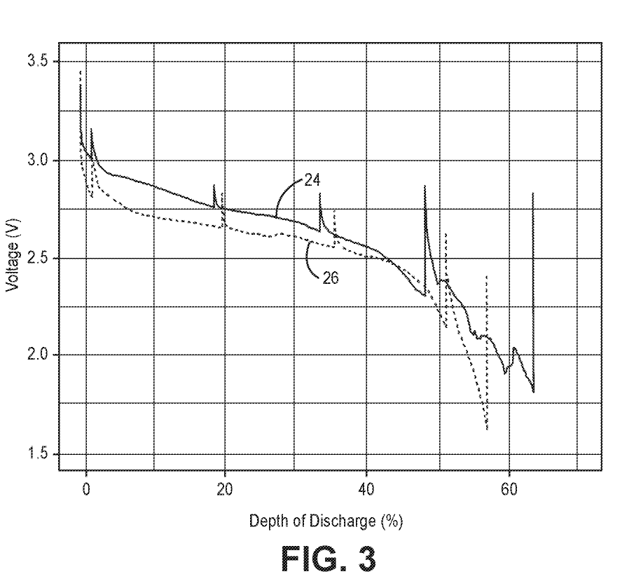

FIG. 3 shows results of electrical discharge of aluminum laminated foil pack cells using the liquid electrolyte composition of Examples 13 and 1. Curve 24 shows discharge data (3-month discharge rate) for an aluminum laminated foil pack cell made using a cathode having about 50% by volume dry cathode mix and a thickness of 1.4 mm and the liquid electrolyte composition of Example 13. Curve 26 shows discharge data (3-month discharge rate) for an aluminum laminated foil pack cell made using a cathode having about 50% by volume dry cathode mix and a thickness of 1.4 mm and the liquid electrolyte composition of Example 1.

The data in FIG. 3 show that cells with reduced ionic conductivity (polymer solution electrolytes represented by examples 1 and 13) in comparison to conventional liquid electrolytes (CE1-CE12), greater than 50% discharge capacity was achieved at the accelerated discharge rate with thick (1.4 mm) cathodes. The liquid electrolyte compositions provide reduced volatility which allows the use of polymer sealed enclosures such as aluminum laminated foil pack cells for long life applications, and the use of high-vacuum, leak check methods during manufacture of the batteries after cells have been filled with electrolyte.

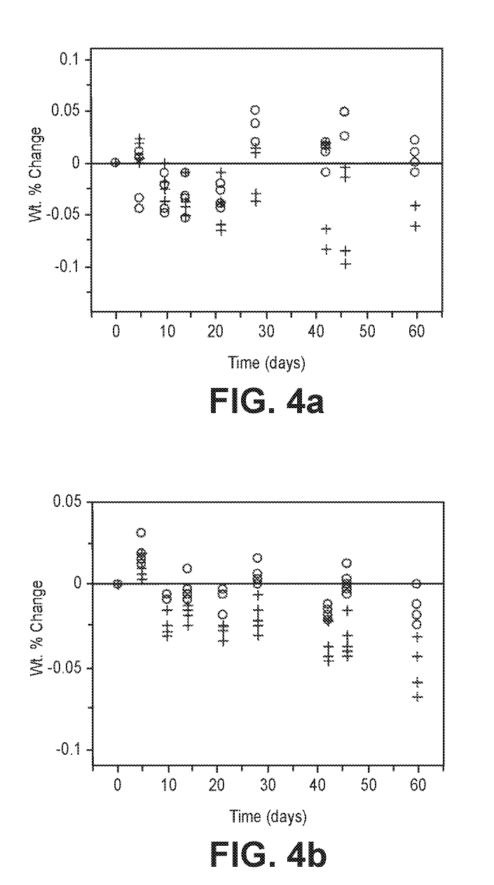

FIGS. 4a and 4b show the results of a weight change under vacuum test of coin cells and aluminum laminated foil pack cells, respectively, containing a liquid electrolyte composition of the disclosure and a comparative polymer gel electrolyte. Coin cells and aluminum laminated foil pack cells were prepared as described above and stored in a vacuum oven (−28 inches Hg; 60° C.) for 60 days. Data shown with “+” symbol was from cells containing the liquid electrolyte composition of Example 19. Data shown with “O” symbol was from cells containing the electrolyte composition of Comparative Example 13. Cathodes having a thickness of 0.7 mm with 40 volume % dry cathode mix were used for the studies in both coin cells and aluminum laminated foil pack cells. Separators were prepared by dipping microporous polyolefin separator (Celgard 2500) in electrolyte maintained at a temperature of 75° C.

The data in FIGS. 4a and 4b show that low leakage cells can be constructed with liquid electrolyte compositions formulated with volatile liquid electrolytes, and that the leakage performance compares favorably to that achieved with polymer gel electrolytes formulated by combining polymers with low volatility electrolytes such as solvate ionic liquids. Liquid electrolyte compositions are capable of providing higher rate capability in batteries, especially with thick electrodes (0.3 mm-5 mm), in comparison to low volatility electrolytes such as ionic liquid gels and/or solid state electrolytes which can suffer from interface resistance issues or diffusion limitations. For example, see Alan C. Luntz, Johannes Voss, Karsten Reuter, Journal of Physical Chemistry, Vol. 6, pp 4599-4604, 2015

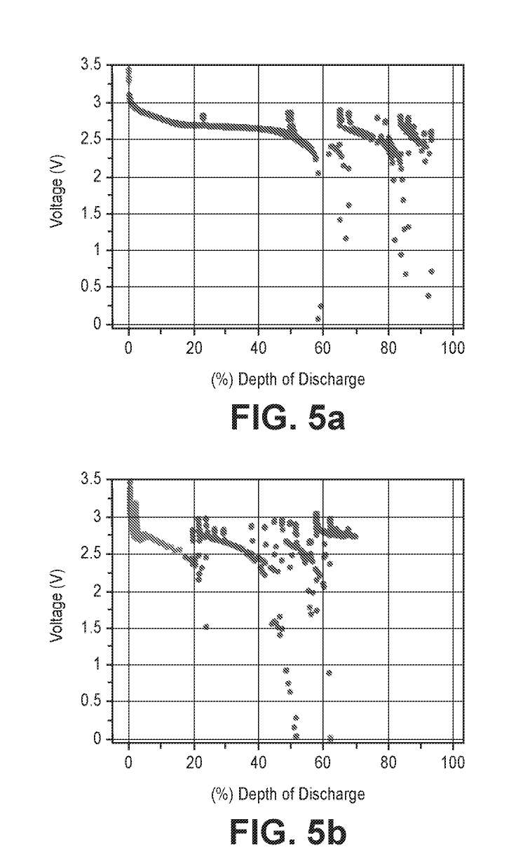

FIGS. 5a and 5b show electrical discharge testing of coin cells (FIG. 5 a) and aluminum laminated foil pack cells (FIG. 5 b) using electrolyte of Example 16. The coin cells (2032 size) contained 0.7 mm thick cathodes having about 50% by volume of dry cathode mixture, the electrolyte composition of Example 16 and a microporous polyolefin separator (Celgard™ 2500) prepared by immersing the separator in electrolyte composition having at temperature of 60° C. The coin cells were discharged at progressively decreasing current drains, starting at a 25-day rate, followed by a 51-day rate, and subsequently at a 102-day rate.

The aluminum laminated foil pack cells contained 1.4 mm thick cathodes having about 50% by volume of dry cathode mixture, the electrolyte composition of Example 16 and a microporous polyolefin separator (Celgard™ 2500) prepared by dispensing electrolyte composition onto the separator. The aluminum laminated foil pack cells were discharged at progressively decreasing current drains, starting at an 85-day rate, followed by a 170-day rate, a 286-day rate, a 426-day rate, and subsequently at a 940-day rate.

The coin and aluminum laminated foil pack cells were discharged at high currents initially until a voltage cut-off of 0 V was reached, and subsequently switched to lower currents, again with a 0 V cut-off, to discharge the entire capacity of the cell. The data of FIGS. 5a and 5b show that thinner cathodes enable higher power batteries, that is, a greater fraction of the discharge capacity can be achieved in a shorter time as compared to batteries having thicker cathodes.

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

What is claimed is:

1. A electrolyte composition containing a solubilized polymer comprising:
a liquid solution resulting from the combination of
a lithium salt;
a solvent or a mixture of solvents having a boiling point of at least 200° C.; and
a polymer that is soluble in the electrolyte composition in an amount of from 2 to 25 weight percent based on the total weight of the electrolyte composition.

2. The electrolyte composition of claim 1 wherein the polymer is selected from the group consisting of: polyethylene oxide, poly(ethylene-co-propylene oxide), poly (methyl methacrylate), poly(lithium acrylate), poly(butyl acrylate), poly(butyl methacrylate), methyl cellulose, hydroxypropyl methyl cellulose, cellulose acetate, and mixtures thereof.

3. The electrolyte composition of claim 1 wherein the solvent or mixture of solvents having a boiling point of at least 200° C. is selected from the group consisting of propylene carbonate, ethylene carbonate, dimethoxyethane, Gamma butyrolactone, dimethylacetamide, N-methylpyrrolidone, tetraethylene glycol dimethyl ether and mixtures thereof.

4. The electrolyte composition of claim 1 wherein the lithium salt is selected from the group consisting of: lithium bis(trifluoromethylsulfonyl) imide (LiTFSI), lithium bis(fluorosulfonyl)imide (LiFSI)lithium bis(pentafluoroethylsulfonyl) imide (LiBETI), lithium tris(trifluorosulfonyl) methide, lithium perchlorate (LiClO₄), lithium tetrafluoroborate (LiBF₄), lithium hexafluoroarsenate (LiAsF₆), lithium hexafluorophosphate (LiPF₆), Lithium bis(oxalatoborate) (LiBOB), lithium trifluoromethanesulfonate (LiCF3SO3) and combinations thereof.

5. The electrolyte composition of claim 1 wherein the lithium salt is present in the electrolyte composition in an amount of from 11 to 50 percent by weight based on the total weight of the electrolyte composition.

6. The electrolyte composition of claim 1 wherein the solvent is present in the electrolyte composition in an amount of from 30 to 76 percent by weight based on the total weight of the electrolyte composition.

7. The electrolyte composition of claim 1 wherein the solvent having a boiling point of at least 200° C. is a mixture of propylene carbonate and dimethoxyethane, propylene carbonate and tetraglyme, Gamma butyrolactone and tetraglyme, Gamma butyrolactone and dimethoxyethane and ethylene carbonate and dimethoxyethane.

8. The electrolyte composition of claim 7 wherein each of the solvent mixtures is present in a ratio of 1:1 by volume.

9. The electrolyte composition of claim 1 having a storage modulus of less than 10 Pa (1 Hz, 37° C.).

10. The electrolyte composition of claim 1 wherein the lithium salt is lithium hexafluoroarsenate, the solvent is a mixture of propylene carbonate and dimethoxyethane and the polymer is polyethylene oxide.

11. A battery comprising:
a negative electrode;
a positive electrode having a thickness of from >300 μm to 5 mm;
a separator between the negative and positive electrodes; and
an electrolyte composition comprising a liquid solution resulting from the combination of a lithium salt, a solvent having a boiling point of at least 200° C., and a polymer that is soluble in the electrolyte composition in an amount of from 2 to 25 weight percent based on the total weight of the electrolyte composition.

12. The battery of claim 11 wherein the negative electrode, the positive electrode, the separator and the electrolyte are within a laminated metal foil pack casing.

13. The battery of claim 11 wherein the liquid electrolyte composition has an ionic conductivity of at least 1 mS/cm at 37° C.

14. The battery of claim 11 wherein the negative electrode is lithium metal.

15. The battery of claim 14 wherein the positive electrode is silver vanadium oxide/carbon monofluoride.

16. The battery of claim 12 wherein the laminated metal foil pack casing has a polymeric seal.

17. The battery of claim 15 wherein the lithium salt is selected from the group consisting of: lithium bis(trifluoromethylsulfonyl) imide (LiTFSI), lithium bis(fluorosulfonyl)imide (LiFSI)lithium bis(pentafluoroethylsulfonyl) imide (LiBETI), lithium tris(trifluorosulfonyl) methide, lithium perchlorate (LiClO₄), lithium tetrafluoroborate (LiBF₄), lithium hexafluoroarsenate (LiAsF₆), lithium hexafluorophosphate (LiPF₆), Lithium bis(oxalatoborate) (LiBOB), lithium trifluoromethanesulfonate (LiCF3SO3) and combinations thereof;
the solvent having a boiling point of at least 200° C. is selected from the group consisting of propylene carbonate, ethylene carbonate, dimethoxyethane, Gamma butyrolactone, dimethylacetamide, N-methylpyrrolidone, tetraethylene glycol dimethyl ether and mixtures thereof; and
the polymer is selected from the group consisting of: polyethylene oxide, poly(ethylene-co-propylene oxide), poly (methyl methacrylate), poly(lithium acrylate), poly(butyl acrylate), poly(butyl methacrylate), methyl cellulose, hydroxypropyl methyl cellulose, cellulose acetate, and mixtures thereof.

18. The battery of claim 17 wherein the lithium salt is lithium hexafluoroarsenate (LiAsF₆) or lithium bis(trifluoromethylsulfonyl) imide (LiTFSI), the solvent is propylene carbonate, dimethoxyethane, tetraethylene glycol dimethyl ether or a combination thereof, and the polymer is polyethylene oxide.

19. The battery of claim 18 wherein the electrolyte composition has a storage modulus of less than 10 Pa (1 Hz, 37° C.).

20. The battery of claim 19 wherein the lithium salt is lithium hexafluoroarsenate, the solvent having a boiling point of at least 200° C. is a mixture of propylene carbonate and dimethoxyethane and the polymer is polyethylene oxide.
